(19) United States
(12) Patent Application Publication
(10) Pub. No.: US 2007/0067614 A1
(43) Pub. Date: Mar. 22, 2007

(54) Booting multiple processors with a single flash ROM

(76) Inventors: Robert W. Berry JR., Round Rock, TX (US); Christopher R. Conley, Pflugerville, TX (US); Michael Criscolo, Cedar Park, TX (US); Michael T. Saunders, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/230,335

(22) Filed: Sep. 20, 2005

(51) Int. Cl. G06F 15/177

(52) U.S. Cl. 713/1

(57) ABSTRACT

A method, apparatus and computer-usable medium are presented for loading firmware onto multiple processors. A firmware controller is coupled to multiple processors and a firmware memory. A service processor, by controlling the operation of the firmware controller, selects one or more of the multiple processors. Under the control of the service processor, the firmware controller sends firmware from the firmware memory to each of the selected processors, either sequentially or simultaneously. If one of the selected processors fails to fully execute the firmware from the firmware memory, the firmware controller notifies the service processor of that failure as well as the particular memory address in the firmware where the failure occurred.

### BACKGROUND OF THE INVENTION

1. Technical Field

The present invention relates in general to the field of computers, and in particular to computers having multiple processors. Still more particularly, the present invention relates to a method and system for loading a Basic Input/Output System (BIOS) firmware from a single flash Read Only Memory (ROM) into selected processors in a computer.

2. Description of the Related Art

Modern computers often have multiple processors that provide improved processing speed and performance over a single processor system. A typical multi-processor computer system is shown in FIG. 1a as blade server 100, which is part of a multi-blade server chassis (not shown).

Blade server 100 has a service processor 102, which coordinates and controls operations of multiple processors 104a-n. Each processor 104 has a dedicated static memory for storing boot firmware. This static memory is depicted in FIG. 1a as a Basic Input/Output System (BIOS) 106.

When a processor 104 is powered on, several stages occur before the processor is useful. First, the processor 104 must run code in its dedicated BIOS 106. This code contains low-level instructions to the processor 104. These low-level instructions set the contents of registers and other components in the processor 104 that permit the processor 104 to recognize keyboard and mouse input devices, establish internal data pathways, etc. Once the processor 104 has run the BIOS 106, it is able to load an Operating System (OS), either from a local hard drive or from a “boot server,” which can upload an OS (but not BIOS code). Once the processor 104 has one or more OS's loaded, it can install one or more application programs, such as a word processor, a spreadsheet program, etc.

FIG. 1b shows a table of software layers 108 related to the stages described above. The applications in Layer 3 “talk” to the OS in Layer 2 (via a software standard interface), which “talks” to the system BIOS in Layer 1. Note that the hardware is in “Layer 0” since it is not actually a software level, but which interfaces nonetheless with the BIOS in Layer 1. Note also that each higher layer is unable to function unless the lower layer(s) are installed and operational.

A stated above in reference to FIG. 1a, each processor 104 has a dedicated BIOS 106, which contains firmware that enables the processor 104 to load an OS. Typically, the firmware in the BIOS 106 is automatically and autonomously executed when a “power on” or “reset” signal is sent to the processor 104. Because the BIOS firmware execution is autonomous, several problems are created if one of the processors 104 fails to properly execute the BIOS firmware.

First, the service processor 102 will not know that a processor 104 failed to execute its firmware (located in its BIOS 106) until the service processor 102 calls that particular processor 104 to perform some function, such as running an application. For example, if the service processor 102 was expecting to have the resources of four processors 104, but only three properly executed their BIOS firmware, then the service processor 102 must decide to 1) continue executing a routine with only three processors 104, or 2) conscript a backup processor to take the place of the failed processor 104. Typically, such decisions are time consuming, and may be disastrous in a mission critical application.

Second, a processor 104 that failed to properly execute its firmware will be unable to self-diagnose the problem. Each processor 104 has no software intelligence until it has loaded, at a minimum, its OS, and preferably has loaded at least one diagnostic application program. Thus, by failing to fully execute its BIOS 106 firmware, the failed processor 104 has neither an OS nor a loaded application to self-diagnose what type of failure (typically hardware related) caused the firmware to not execute.

### SUMMARY OF THE INVENTION

To address the problem described in the prior art, a method, apparatus and computer-usable medium are presented for loading firmware onto multiple processors. A firmware controller is coupled to multiple processors and a firmware memory. A service processor, by controlling the operation of the firmware controller, selects one or more of the multiple processors. Under the control of the service processor, the firmware controller sends firmware from the firmware memory to each of the selected processors, either sequentially or simultaneously. If one of the selected processors fails to fully execute the firmware from the firmware memory, the firmware controller notifies the service processor of that failure as well as the particular memory address in the firmware where the failure occurred.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1a illustrates a prior art multi-processor blade server;

FIG. 1b depicts software layers used in a typical computer;

FIG. 2a illustrates a high-level schematic of a firmware controller coupled to multiple processors and a single dedicated firmware memory on a first blade server;

FIG. 2b depicts additional detail of a service processor shown in FIG. 2a;

FIG. 2c illustrates a second blade server that has multiple backup processors available to the service processor shown in FIG. 2b;

FIG. 2d depicts additional detail of the firmware controller shown in FIG. 2a;

FIG. 3 illustrates a third party administrator's server that is capable of uploading software, which is used to control the firmware controller of the first blade server shown in FIG. 2a;

FIG. 4 is a flow-chart of exemplary steps taken to provide firmware to multiple processors;

FIGS. 5a-b show a flow-chart of steps taken to deploy software capable of executing the steps shown and described in FIG. 4;

FIGS. 6a-c show a flow-chart of steps taken to deploy in a Virtual Private Network (VPN) software that is capable of executing the steps shown and described in FIG. 4;

FIGS. 7a-b show a flow-chart showing steps taken to integrate into an computer system software that is capable of executing the steps shown and described in FIG. 4; and

FIGS. 8a-b show a flow-chart showing steps taken to execute the steps shown and described in FIG. 4 using an on-demand service provider.

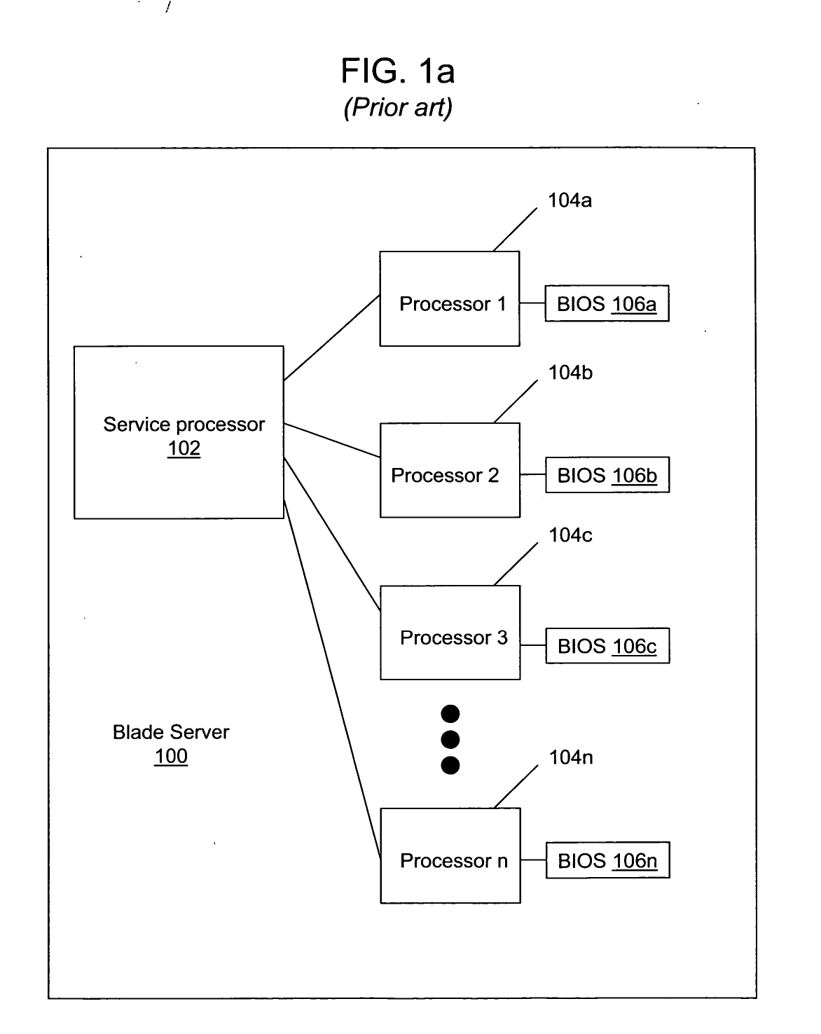

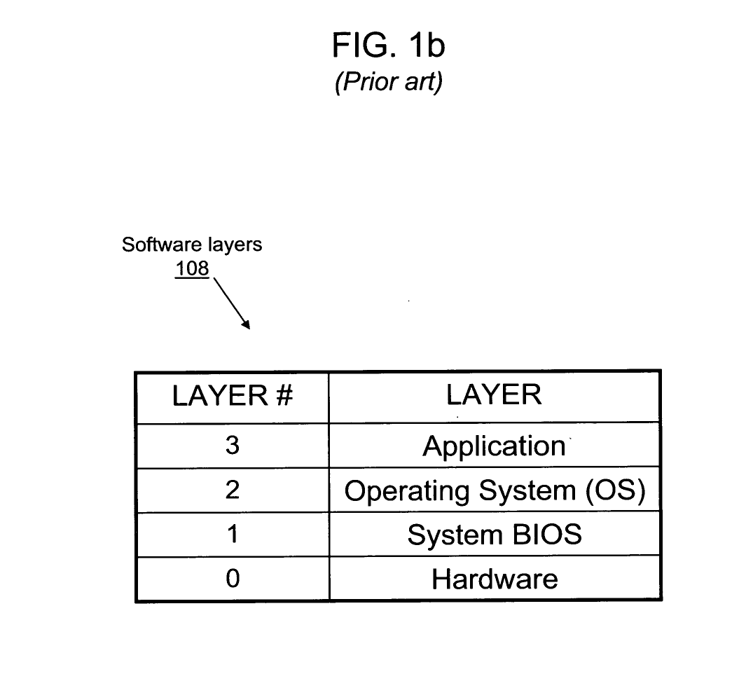

### DETAILED DESCRIPTION OF THE PREFERRED EMBODIMENT

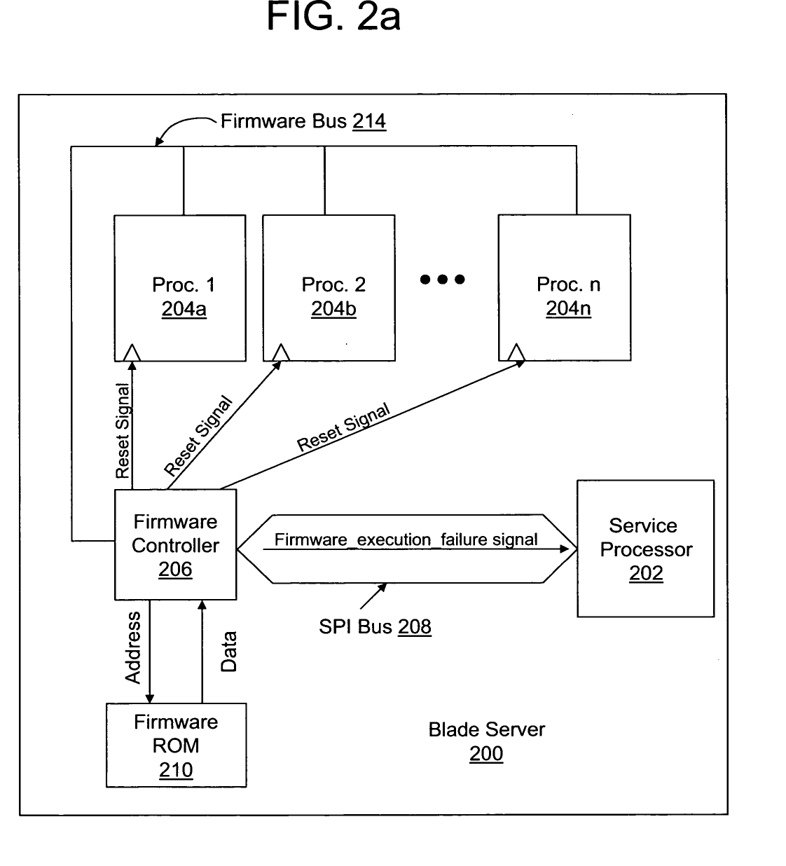

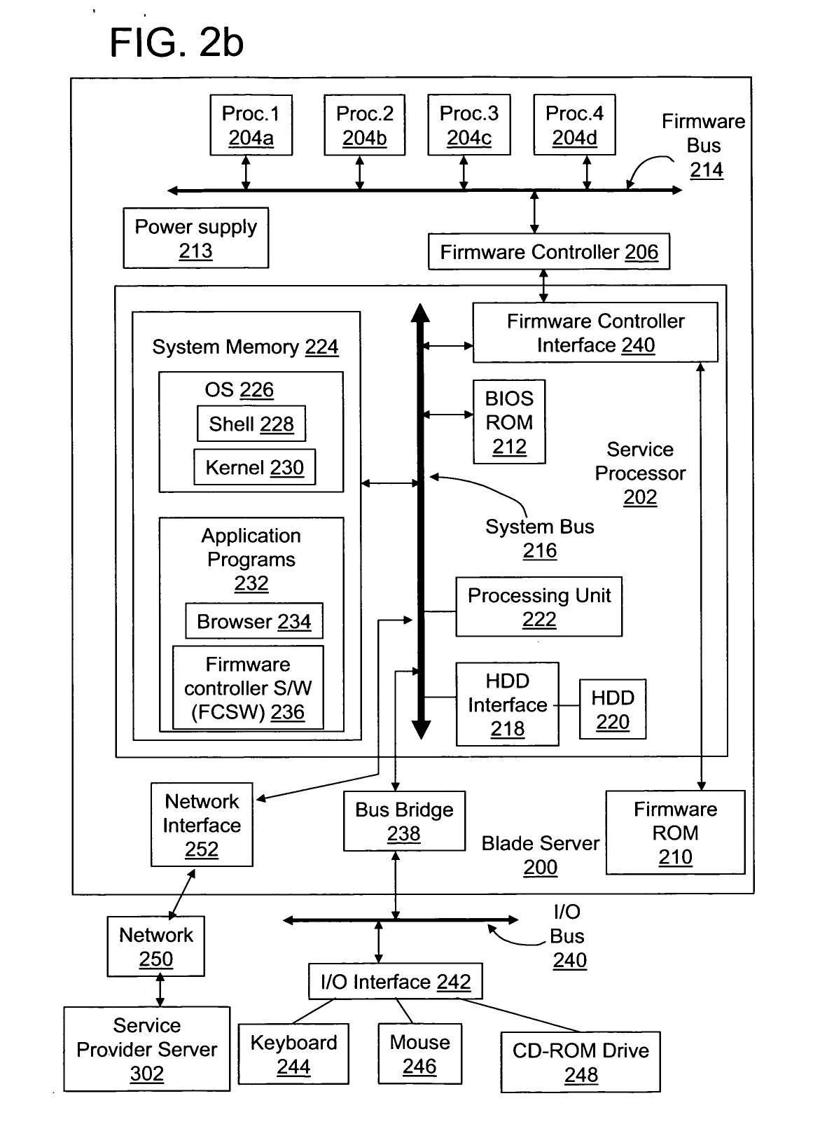

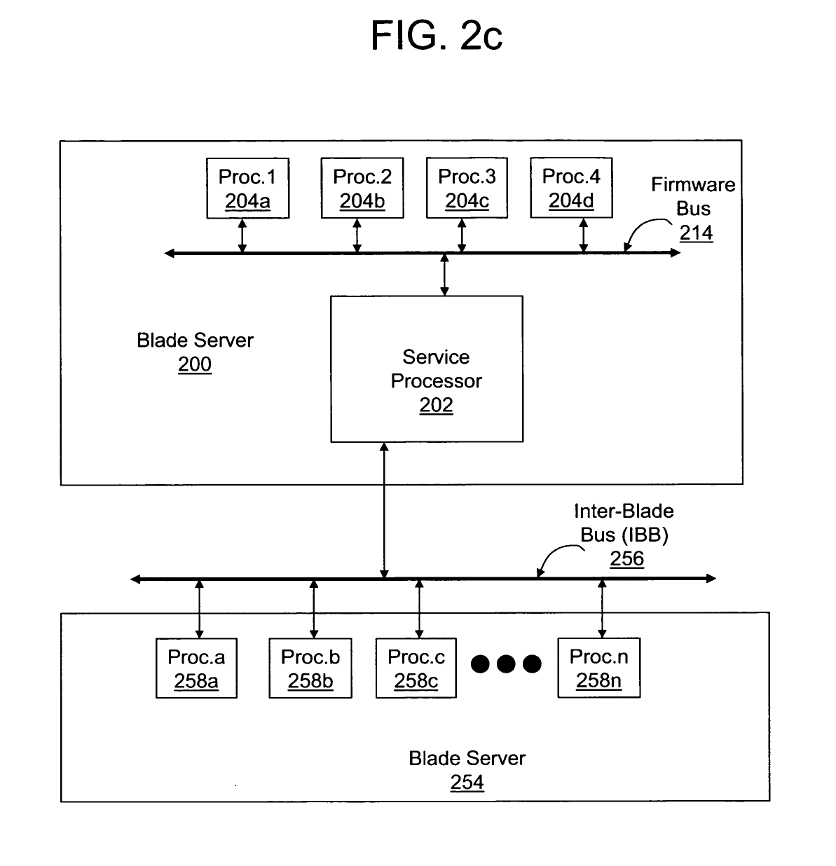

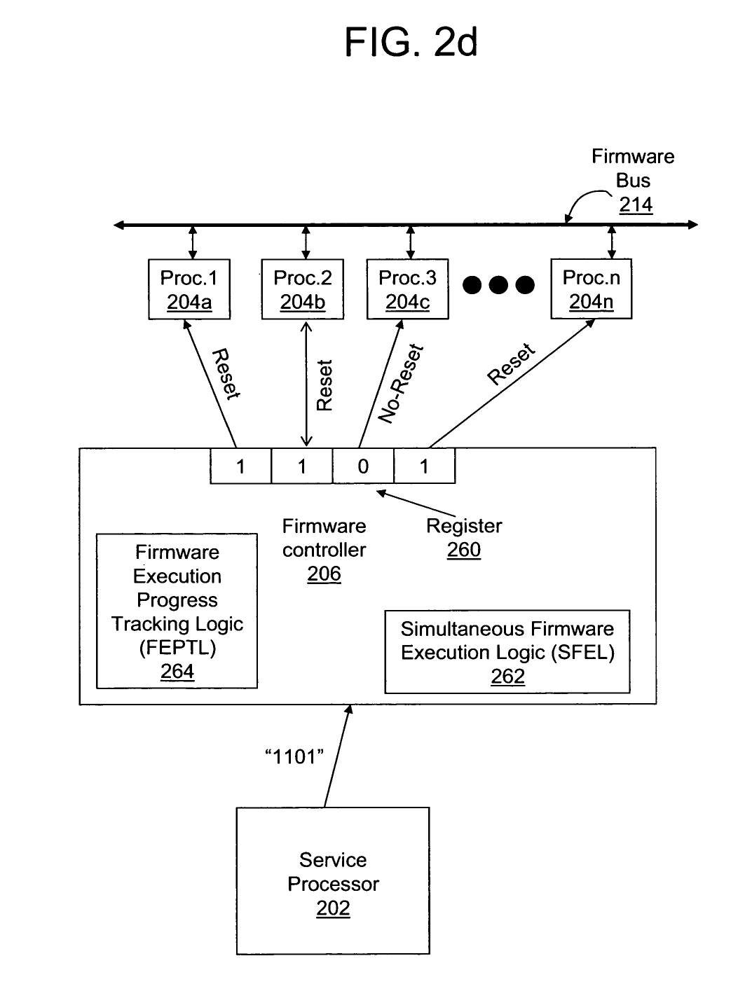

With reference now to FIG. 2a, there is depicted a block diagram of an exemplary blade server 200, in which the present invention may be utilized. Blade server 200 includes a service processor 202, which controls the function and coordination of a multiple processors 204.

Service processor 202 is coupled to a firmware controller 206 via a Serial Peripheral Interface (SPI) bus 208. Alternatively, SPI bus 208 may be an Inter-IC (12C) bus or any other internal high-speed bus. In one preferred embodiment, firmware controller 206 is a Field Programmable Gate Array (FPGA), which can be programmed using firmware controller software 236 described below.

A firmware Read Only Memory (ROM) 210 is also coupled to firmware controller 206. Firmware ROM 210 is an exemplary memory, which is preferably non-volatile, that is dedicated to exclusively containing firmware such as Basic Input/Output System (BIOS) code.

As shown in FIG. 2a, firmware controller 206 is able to send a reset signal to one or more processors 204 under the control and direction of service processor 202. Each reset signal causes a processor 204 to be initialized to execute BIOS-type firmware. If execution of such BIOS-type firmware fails in any particular processor 204, then firmware controller 206 sends a “Firmware_execution_failure signal” to service processor 202, indicating which processor 204 failed to fully execute the firmware in firmware ROM 210 and where in the firmware code the failure occurred.

Note that a firmware bus 214 couples processors 204 with firmware controller 206. This firmware bus 214 is dedicated to carrying only firmware from firmware ROM 210 to selected processors 204. Having a single dedicated firmware bus 214 provides improved performance in monitoring the progress of firmware execution in each processor 204, as provides a more efficient and faster medium than using a shared non-dedicated bus on the blade server 200.

With reference now to FIG. 2b, additional detail is shown for blade server 200, including service processor 202. Service processor 202 is preferably autonomous from processors 204, such that service processor 202 has its own BIOS ROM 212, which may or may not contain the same firmware found in firmware ROM 210. Similarly, service processor 202 is able to be powered up by power supply 213 before, and independent of, processors 204.

Service processor 202 has an internal system bus 216 coupled to BIOS ROM 212 as well as processing unit 222, which includes one or more processors (not shown) used to execute operation associated with the functionality of service processor 202. A Hard Disk Drive (HDD) interface 218 provides an interface between system bus 216 and an HDD 220.

In a preferred embodiment, HDD 220 populates a system memory 224, which is also coupled to system bus 216. Data that populates system memory 224 includes service processor 202's operating system (OS) 226 as well as application programs 232 capable of being executed by, or under the direction of, service processor 202.

OS 226 includes a shell 228 for providing transparent user access to resources such as application programs 232. Generally, shell 228 is a program that provides an interpreter and an interface between the user and the operating system. More specifically, shell 228 executes commands that are entered via a command line user interface or from a file. Thus, shell 228 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 230) for processing.

As depicted, OS 226 also includes kernel 230, which includes lower levels of functionality for OS 226, including provision of essential services required by other parts of OS 226 and application programs 232, including memory management, process and task management, disk management, and mouse and keyboard management.

Application programs 232 include a browser 234. Browser 234 includes program modules and instructions enabling a World Wide Web (WWW) client (i.e., service processor 202) to send and receive network messages to the Internet using HyperText Transfer Protocol (HTTP) messaging, thus enabling communication with service provider server 302.

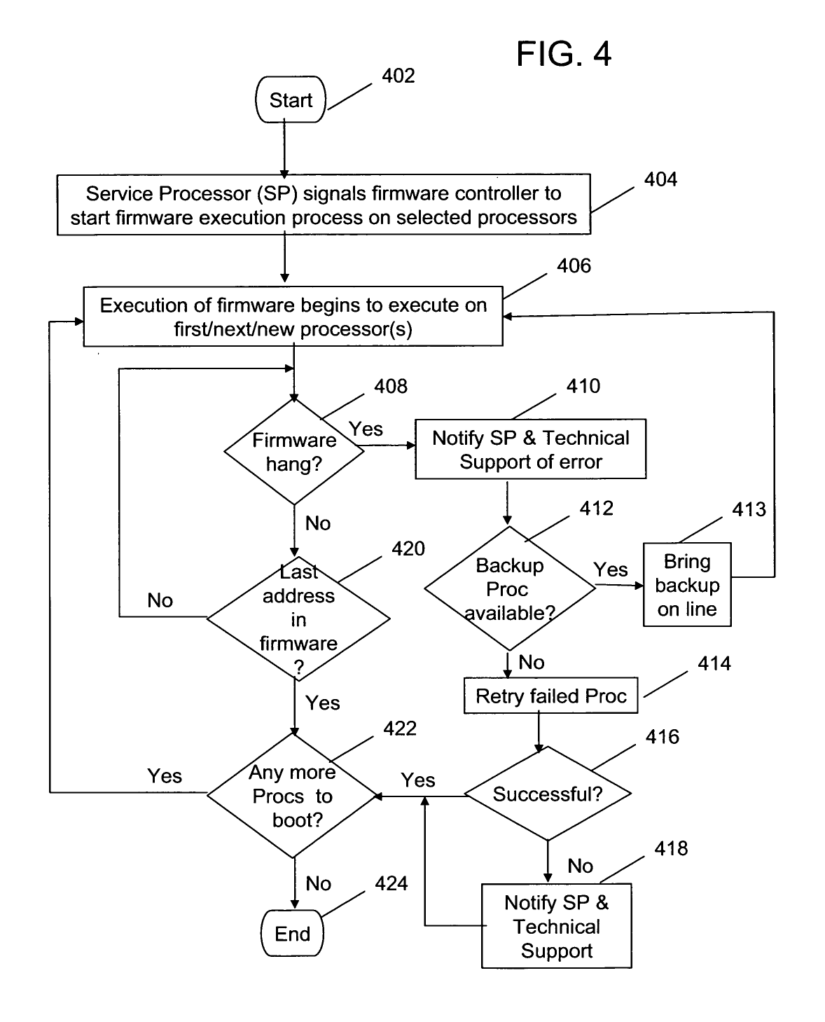

Application programs 232 in service processor 202's system memory also include a Firmware Controller Software (FCSW) 236. FCSW 236 includes software code for performing two main functions. First, FCSW 236 contains code for determining which processor 204 is selected to receive firmware from firmware ROM 210. As part of this first function, FCSW may also include code for conscripting a backup processor if a selected processor fails to fully execute the firmware from firmware ROM 210, determining the point in the firmware where the execution failure occurred, issuing reset signals to the selected processors, and other steps shown below in FIG. 4. Second, if firmware controller 206 is an FPGA, FCSW 236 contains code that may be used to program the FPGA to perform the above described functions by using the programmed-in FPGA hardware.

Blade server 200 also includes a bus bridge 238, which is coupled to an Input/Output (I/O) bus 240. An I/O interface 242 is also coupled to I/O bus 240, thus providing blade server 200 and service processor 202 access to I/O devices such as a keyboard 244, a mouse 246 and a Compact Disk Read Only Memory (CD-ROM) drive 248.

Blade server 200 and service processor 202 are able to communicate with a service provider server 302 via a network 250 using a network interface 252, which is coupled to system bus 216. Preferably, network 250 is the Internet Network, although in other embodiments network 250 may be an Ethernet or any other high-speed network system.

The hardware elements depicted in the example client computer 302 are not intended to be exhaustive, but rather are representative to highlight essential components required by the present invention. For instance, client computer 302 may include alternate memory storage devices such as floppy disk drives, magnetic cassettes, Digital Versatile Disks (DVDs), Bernoulli cartridges, and the like. These and other variations are intended to be within the spirit and scope of the present invention.

As will be discussed below, service processor 202 dictates which processor 204 is to execute firmware from firmware ROM 210. If one of the selected processors 204 has a hardware failure or other type of failure that prevents full execution of the firmware, the service processor 202 conscripts a backup processor to take the place of the failed processor. Preferably, the backup processor is another processor 204 on blade server 200. However, there may be an occasion in which there are no available backup processors on blade server 200. In such a case, service processor 202 calls to another blade server 254 via an Inter-Blade Bus (IBB) 256, as shown in FIG. 2c. Blade server 254 has processors 258a-n, one or more of which are available as a backup for the processor 204 that failed to fully execute the firmware from firmware ROM 210.

As stated earlier, service processor 202 is able to control, which processors 204 execute the firmware from firmware ROM 210 via the firmware controller 206. If firmware controller 206 has fixed logic, then a register 260, as shown in FIG. 2d, contains flags indicating which processor 204 is to be reset and to execute the firmware in firmware ROM 210. For example, assume that service processor 202 sends “1101” to register 260. This content in register 260 would result in a reset signal being sent to processors 204a, 204b and 204n, but not to processor 204c. Note that the “No-Reset” signal is actually no signal at all, thus causing processor 204c to do nothing. Similarly, if firmware controller 206 is an FPGA, then service processor 202 sends a similar type of signal causing gates to be set in the FPGA. This setting of gates results in the same “Reset” or “No-Reset” signals being sent to the appropriate processors.

Note also that, as shown in FIG. 2d, firmware controller 206 includes a Simultaneous Firmware Execution Logic (SFEL) 262. SFEL 262 permits firmware from firmware ROM 210 to be simultaneously executed by multiple processors 204, while monitoring and tracking the exact instruction being executed by each processor 204 in real time. Thus, if processor 204a should experience a firmware hang at an instruction located at a first memory location (e.g., F002ₕₑₓ), while processor 204b experiences a firmware hang at an instruction located at a second memory location (e.g., F1F3ₕₑₓ), then firmware controller 206 includes buffers and/or other logic to store these locations along with their associated processor 204, for later transmission to service processor 202 as a “Firmware_execution_failure signal,” as shown in FIG. 2a. These buffers and/or other logic are depicted in FIG. 2d as Firmware Execution Progress Tracking Logic (FEPTL) 264.

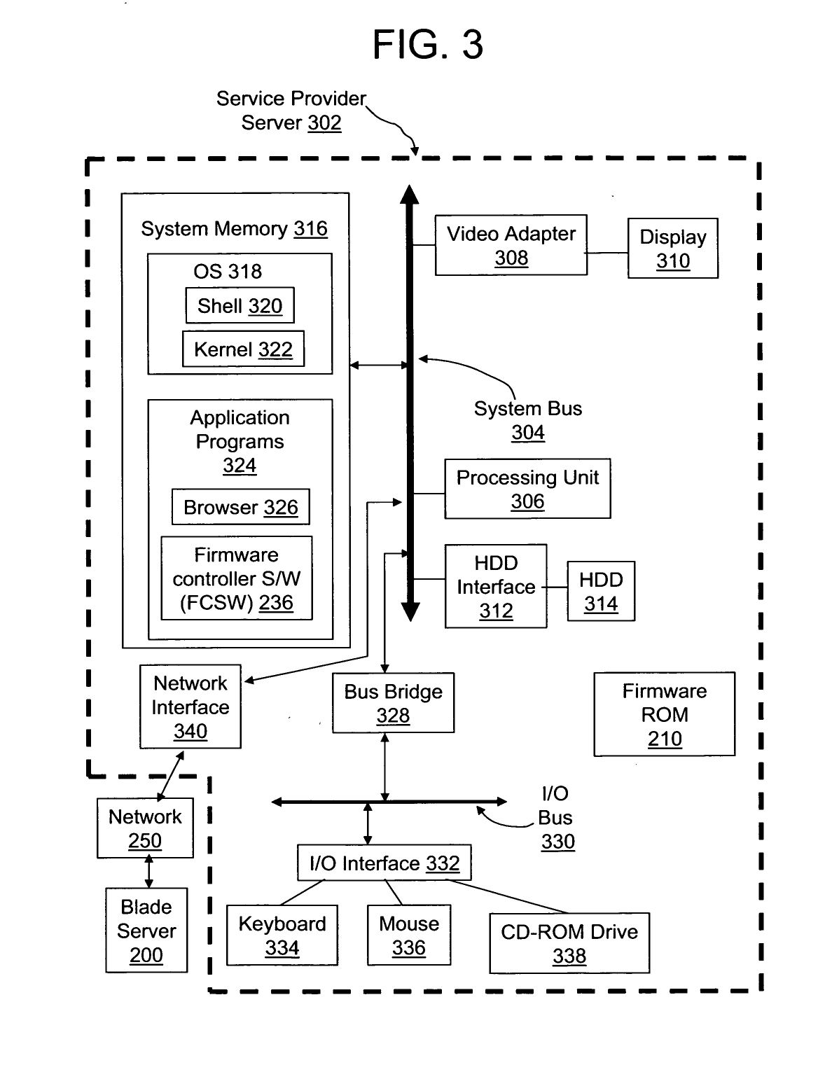

With reference now to FIG. 3, there is depicted a block diagram of details of service provider server 302. Service provider server 302, which is operated by a third party service provider such as IBM Global Services™ (IGS), includes components analogous to those found in blade server 200. These components include a system bus 304, a processing unit 306, a video adapter 308 and associated display 310, and a Hard Disk Drive (HDD) interface 312 and associated HDD 314. Similarly, service provider server 302 includes a system memory 316, which is preferably populated by HDD 314. System memory 316 includes an OS 318, which includes a shell 320 and a kernel 322, as well as application programs 324, which include a browser 326 and FGSW 236. A bus bridge 328, coupled to an I/O bus 330, allows system bus 304 to communicate, via an Input/Output (I/O) interface 332, with I/O devices such as a keyboard 334, a mouse 336, and a CD-ROM drive 338. A network interface 340 affords communication with blade server 200 (and thus service processor 202), via network 250.

The hardware elements depicted in service provider server 302 are not intended to be exhaustive, but rather are representative to highlight essential components required by the present invention.

With reference now to FIG. 4, a flow-chart of exemplary steps taken to execute firmware in multiple processors from a single firmware ROM is shown. After initiator block 402, the service processor (described above) signals the firmware controller to begin executing, on one or more of the selected processors, the firmware located in the firmware ROM (block 404). Execution of the firmware from a single firmware source (e.g., firmware ROM 210 described above) is initiated in one or more of the processors. Note that in one embodiment, this execution is performed sequentially in one processor at a time, while in another embodiment this execution is performed simultaneously in all of the selected processors.

As described in query block 408, if execution of the firmware hangs in the processor (or multiple processors if the firmware is being executed simultaneously in multiple processors), then a signal is sent to the service processor (block 410), including the address of the instruction at which the hang occurred. Optionally, this information may be sent, manually or automatically, to a technical service department for handling of the error, and/or performance of maintenance (e.g., replacement of the failed processor) to prevent a future recurrence of the firmware execution failure.

If a backup processor is available (query block 412), then a new processor is brought on-line (block 413) with the service processor, and execution of the firmware begins in the new processor (block 406). If a backup processor is not available (either on the same or different blade server as the failed processor), then the failed processor can retry to execute the firmware (block 414). (Note that the order of the blocks shown in FIG. 4, and in particular blocks 412 and 414, are not necessarily as depicted. Thus, a failed processor can retry executing the firmware before conscripting a backup processor to replace the failed processor.)

If the entire firmware is not successfully executed after the retry (query block 416), then the service processor and technical support are so notified (block 418), as described above in reference to block 410. However, if the retry was successful, then a query (query block 422) is made as to whether there are more processors needing to execute the firmware. Note that the query in query block 422 is made whether the firmware execution is performed sequentially or simultaneously by the selected processors.

Returning to query block 408, if the execution of the firmware is continuing without a hang, then a query is made as to whether the last address in the firmware has been executed (query block 420). If not, then the firmware continues to execute until either 1) a hang occurs or 2) the last instruction in the firmware is executed. The process ends (terminator block 424) when the selected processor successfully executes the last firmware instruction in ROM. At this point, each processor is able to load operating systems, applications, etc., all preferably under the control of the service processor.

It should be understood that at least some aspects of the present invention may alternatively be implemented in a computer-useable medium containing a program product that includes computer executable instructions configured to perform the steps described herein. Programs defining functions on the present invention can be delivered to a data storage system or a computer system via a variety of signal-bearing media, which include, without limitation, non-writable storage media (e.g., CD-ROM), tangible writable storage media (e.g., a floppy diskette, hard disk drive, read/write CD ROM, optical media), and communication media, such as computer and telephone networks including Ethernet. It should be understood, therefore, that such signal-bearing media, when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Thus, the method described herein, and in particular as shown and described in FIG. 4, can be deployed as a process software from service provider server 302 to blade server 200 and service processor 202. For example, FCSW 236, SFEL 262, and FEPTL 264 described above may be deployed from service provider server 302, thus providing an additional benefit, inter alia, of allowing a single service provider to control the operation of servers and processors used by multiple client customers.

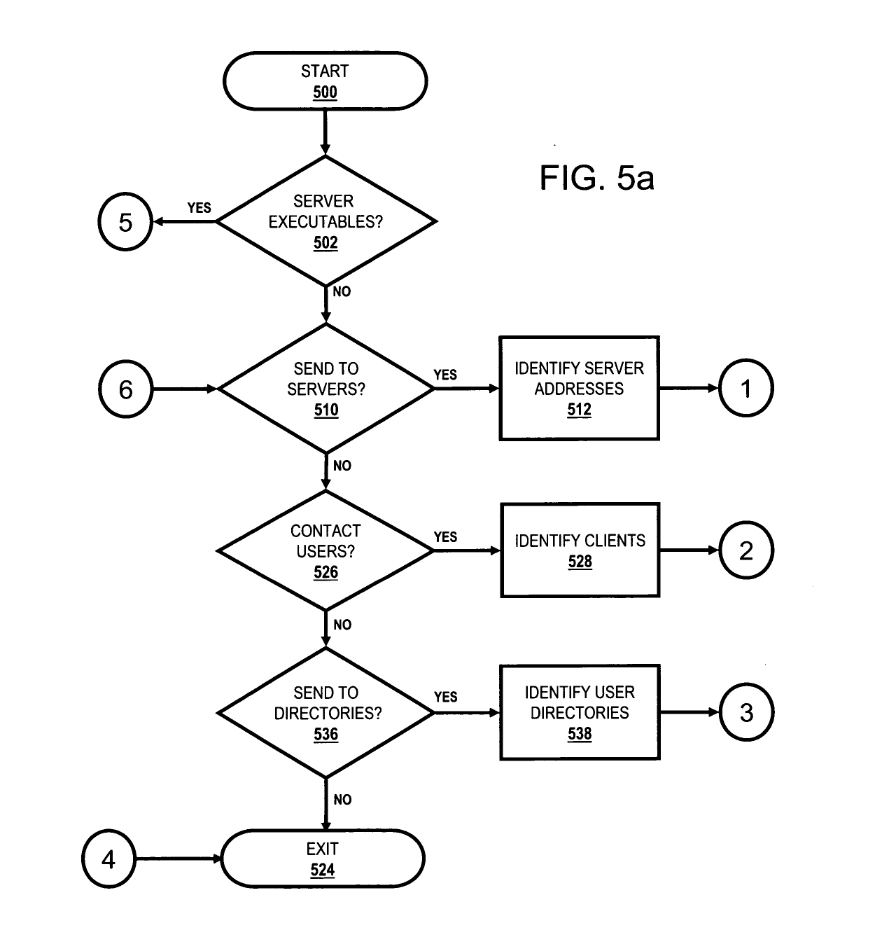

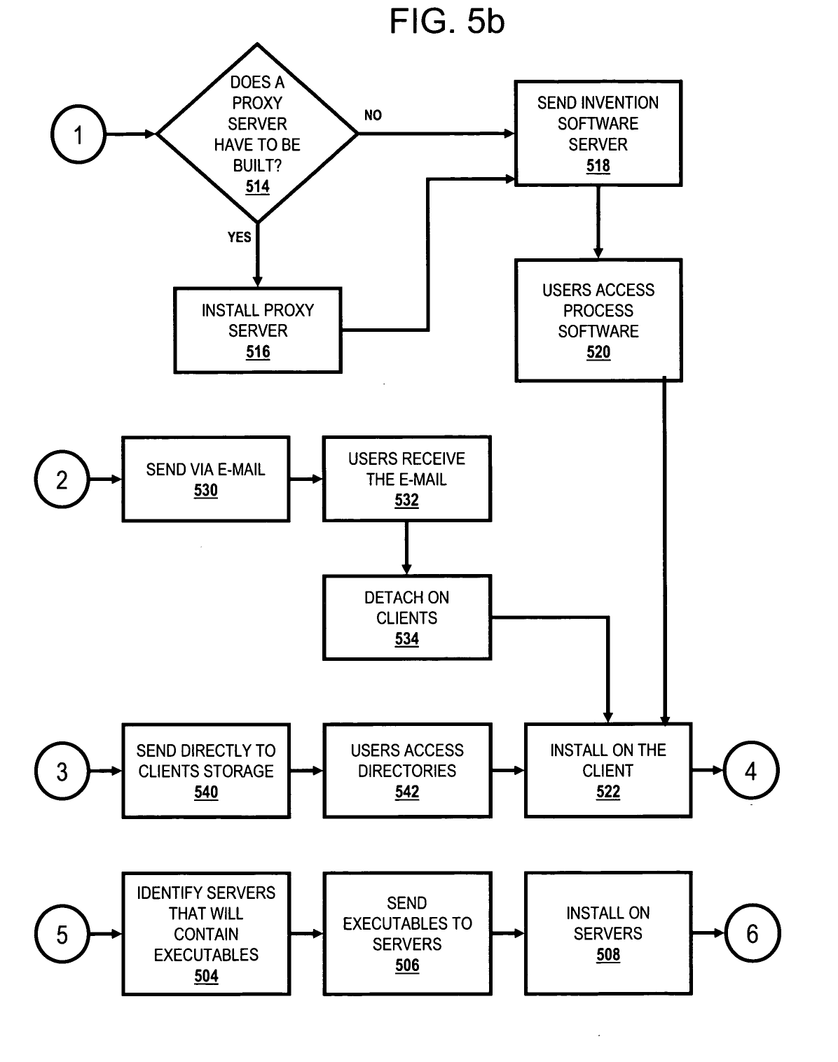

Referring then to FIG. 5, step 500 begins the deployment of the process software. The first thing is to determine if there are any programs that will reside on a server or servers when the process software is executed (query block 502). If this is the case, then the servers that will contain the executables are identified (block 504). The process software for the server or servers is transferred directly to the servers' storage via File Transfer Protocol (FTP) or some other protocol or by copying though the use of a shared file system (block 506). The process software is then installed on the servers (block 508).

Next, a determination is made on whether the process software is be deployed by having users access the process software on a server or servers (query block 510). If the users are to access the process software on servers, then the server addresses that will store the process software are identified (block 512).

A determination is made if a proxy server is to be built (query block 514) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 516). The process software is sent to the servers either via a protocol such as FTP or it is copied directly from the source files to the server files via file sharing (block 518). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 520). Another embodiment is to have the servers automatically copy the process software to each client and then run the installation program for the process software at each client computer. The user executes the program that installs the process software on his client computer (block 522) then exits the process (terminator block 524).

In query step 526, a determination is made whether the process software is to be deployed by sending the process software to users via e-mail. The set of users where the process software will be deployed are identified together with the addresses of the user client computers (block 528). The process software is sent via e-mail to each of the users' client computers (block 530). The users then receive the e-mail (block 532) and then detach the process software from the e-mail to a directory on their client computers (block 534). The user executes the program that installs the process software on his client computer (block 522) then exits the process (terminator block 524).

Lastly a determination is made on whether to the process software will be sent directly to user directories on their client computers (query block 536). If so, the user directories are identified (block 538). The process software is transferred directly to the user's client computer directory (block 540). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 542). The user executes the program that installs the process software on his client computer (block 522) and then exits the process (terminator block 524).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called runnel interfaces, where the packet enters and exits the network.

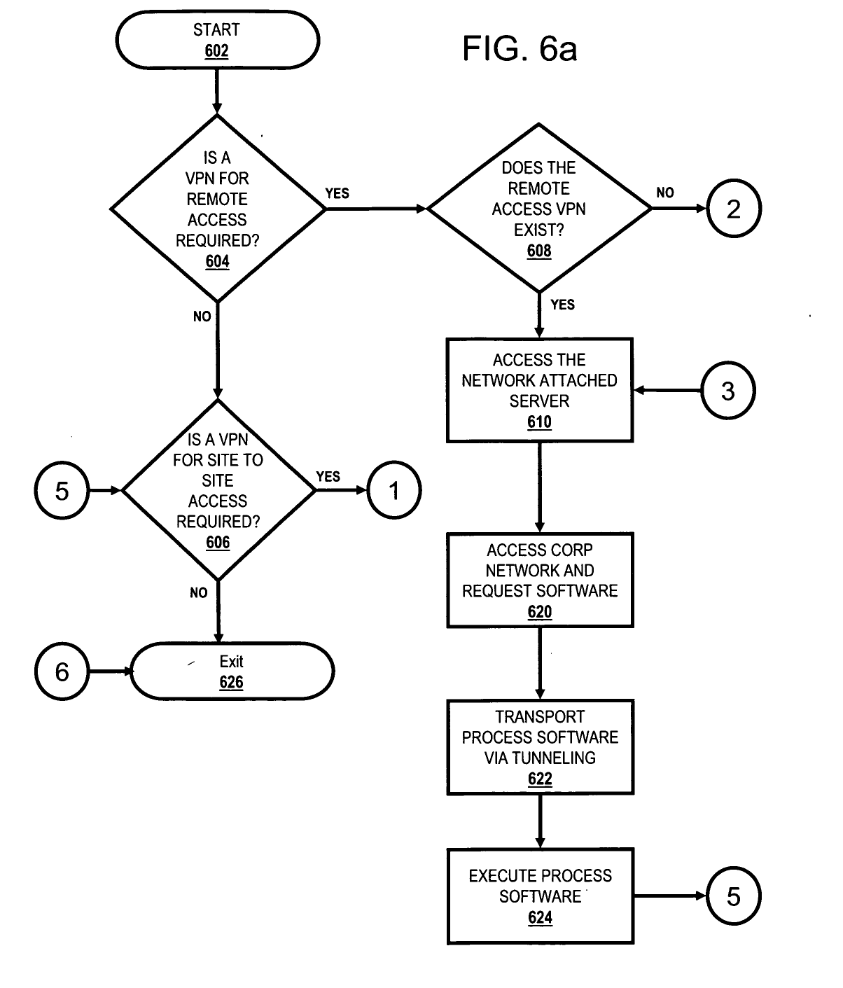

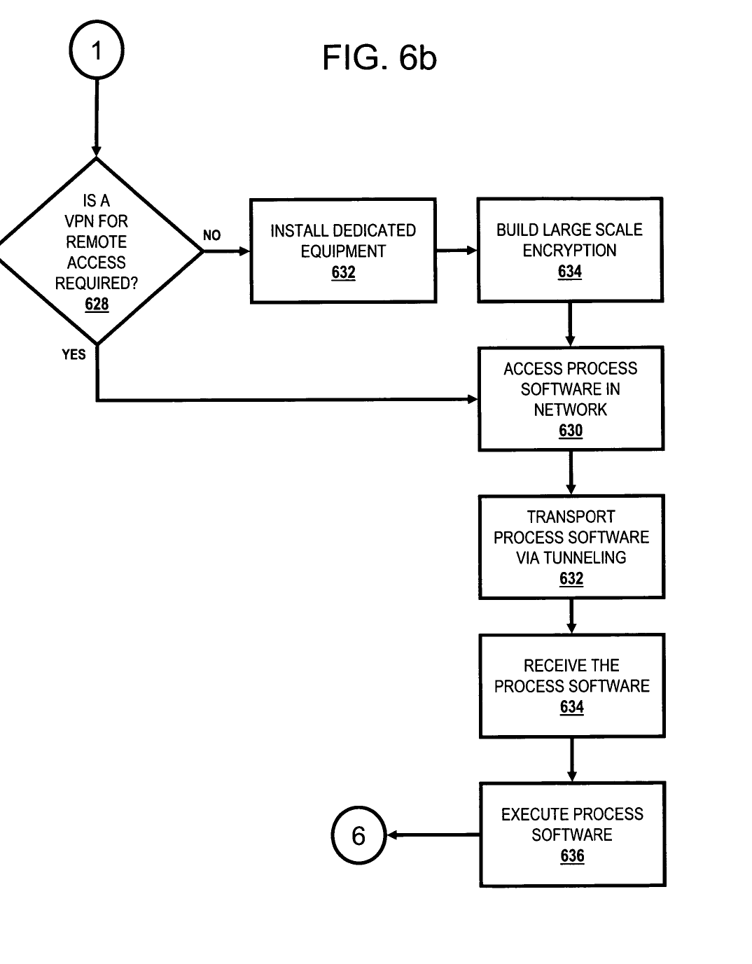

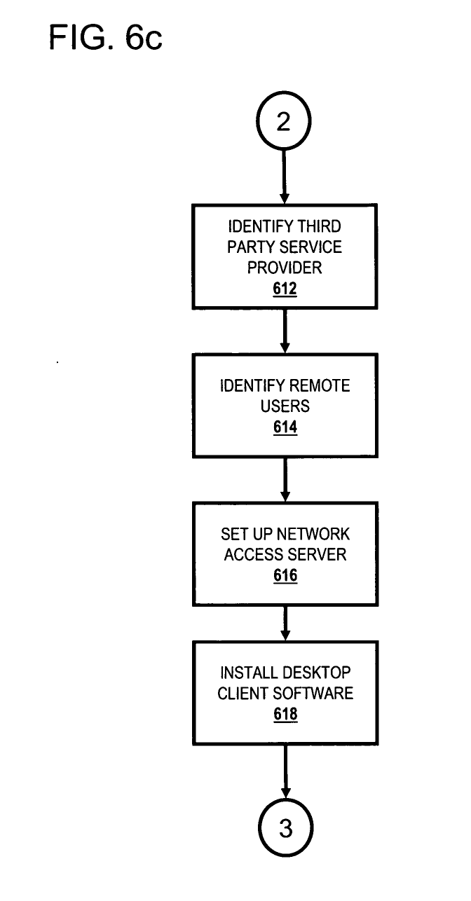

The process for such VPN deployment is described in FIG. 6. Initiator block 602 begins the Virtual Private Network (VPN) process. A determination is made to see if a VPN for remote access is required (query block 604). If it is not required, then proceed to (query block 606). If it is required, then determine if the remote access VPN exists (query block 608).

If a VPN does exist, then proceed to block 610. Otherwise identify a third party provider that will provide the secure, encrypted connections between the company's private network and the company's remote users (block 612). The company's remote users are identified (block 614). The third party provider then sets up a network access server (NAS) (block 616) that allows the remote users to dial a toll free number or attach directly via a broadband modem to access, download and install the desktop client software for the remote-access VPN (block 618).

After the remote access VPN has been built or if it been previously installed, the remote users can access the process software by dialing into the NAS or attaching directly via a cable or DSL modem into the NAS (block 610). This allows entry into the corporate network where the process software is accessed (block 620). The process software is transported to the remote user's desktop over the network via tunneling. That is the process software is divided into packets and each packet including the data and protocol is placed within another packet (block 622). When the process software arrives at the remote user's desk-top, it is removed from the packets, reconstituted and then is executed on the remote users desk-top (block 624).

A determination is then made to see if a VPN for site to site access is required (query block 606). If it is not required, then proceed to exit the process (terminator block 626). Otherwise, determine if the site to site VPN exists (query block 628). If it does exist, then proceed to block 630. Otherwise, install the dedicated equipment required to establish a site to site VPN (block 632). Then build the large scale encryption into the VPN (block 634).

After the site to site VPN has been built or if it had been previously established, the users access the process software via the VPN (block 630). The process software is transported to the site users over the network via tunneling (block 632). That is the process software is divided into packets and each packet including the data and protocol is placed within another packet (block 634). When the process software arrives at the remote user's desktop, it is removed from the packets, reconstituted and is executed on the site users desk-top (block 636). The process then ends at terminator block 626.

Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

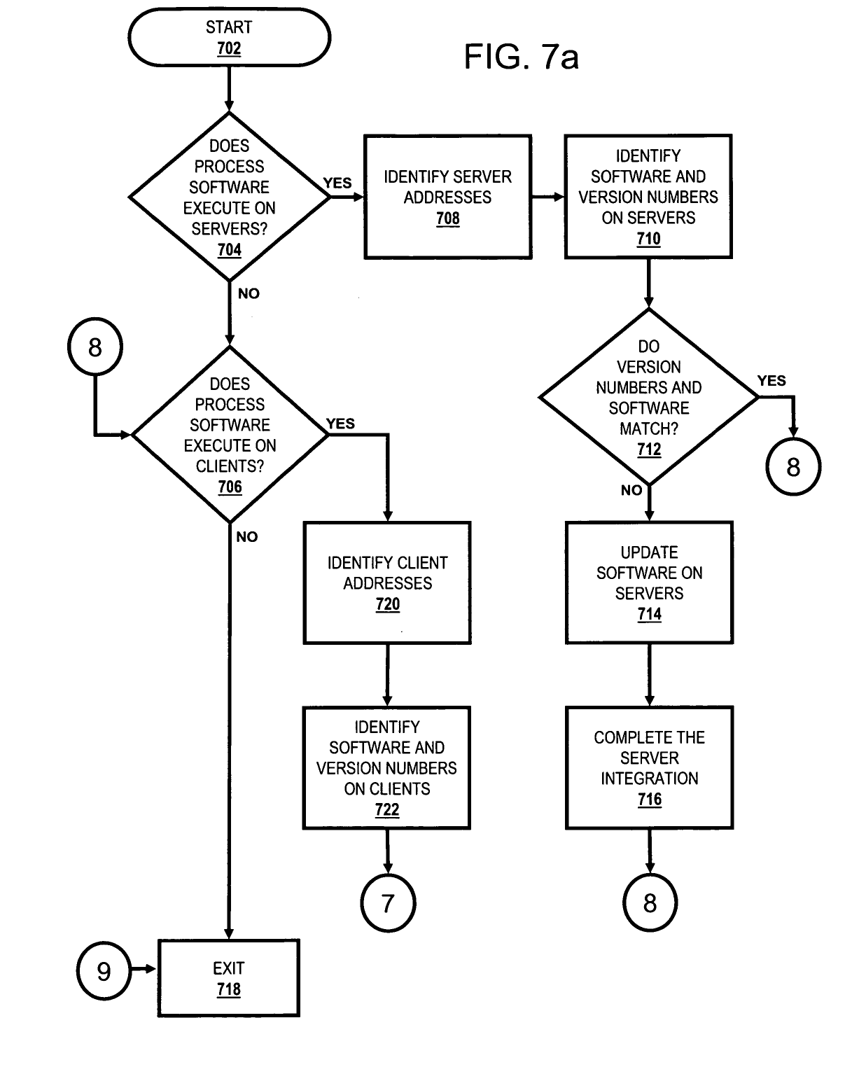

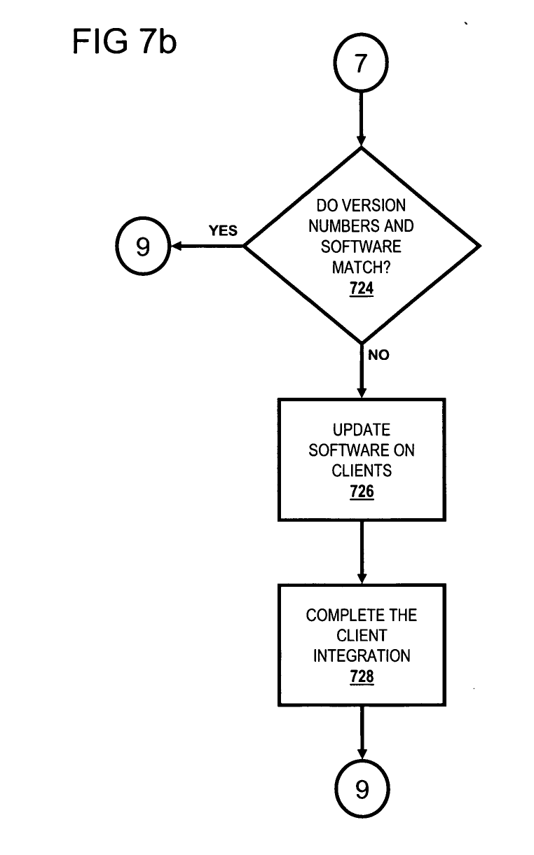

For a high-level description of this process, reference is now made to FIG. 7. Initiator block 702 begins the integration of the process software. The first tiling is to determine if there are any process software programs that will execute on a server or servers (block 704). If this is not the case, then integration proceeds to query block 706. If this is the case, then the server addresses are identified (block 708). The servers are checked to see if they contain software that includes the operating system (OS), applications, and network operating systems (NOS), together with their version numbers, which have been tested with the process software (block 710). The servers are also checked to determine if there is any missing software that is required by the process software in block 710.

A determination is made if the version numbers match the version numbers of OS, applications and NOS that have been tested with the process software (block 712). If all of the versions match and there is no missing required software the integration continues in query block 706.

If one or more of the version numbers do not match, then the unmatched versions are updated on the server or servers with the correct versions (block 714). Additionally, if there is missing required software, then it is updated on the server or servers in the step shown in block 714. The server integration is completed by installing the process software (block 716).

The step shown in query block 706, which follows either the steps shown in block 704, 712 or 716 determines if there are any programs of the process software that will execute on the clients. If no process software programs execute on the clients the integration proceeds to terminator block 718 and exits. If this not the case, then the client addresses are identified as shown in block 720.

The clients are checked to see if they contain software that includes the operating system (OS), applications, and network operating systems (NOS), together with their version numbers, which have been tested with the process software (block 722). The clients are also checked to determine if there is any missing software that is required by the process software in the step described by block 722.

A determination is made is the version numbers match the version numbers of OS, applications and NOS that have been tested with the process software (query block 724). If all of the versions match and there is no missing required software, then the integration proceeds to terminator block 718 and exits.

If one or more of the version numbers do not match, then the unmatched versions are updated on the clients with the correct versions (block 726). In addition, if there is missing required software then it is updated on the clients (also block 726). The client integration is completed by installing the process software on the clients (block 728). The integration proceeds to terminator block 718 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

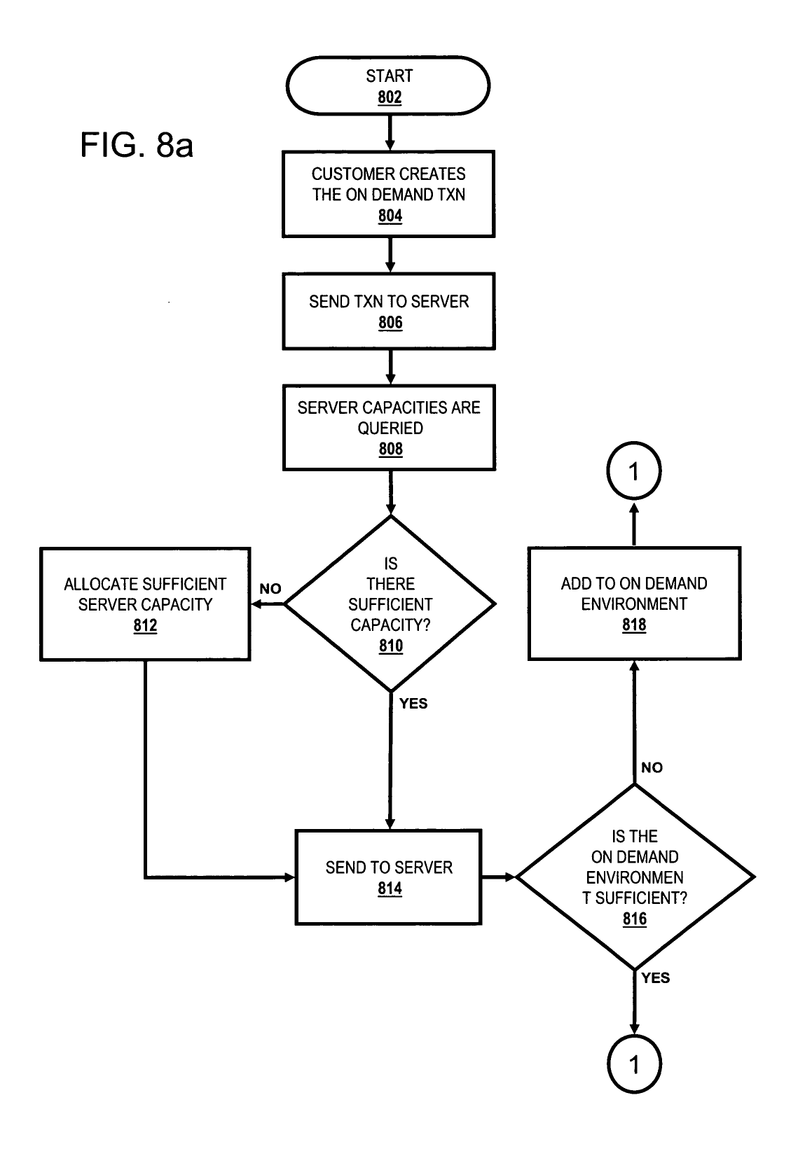

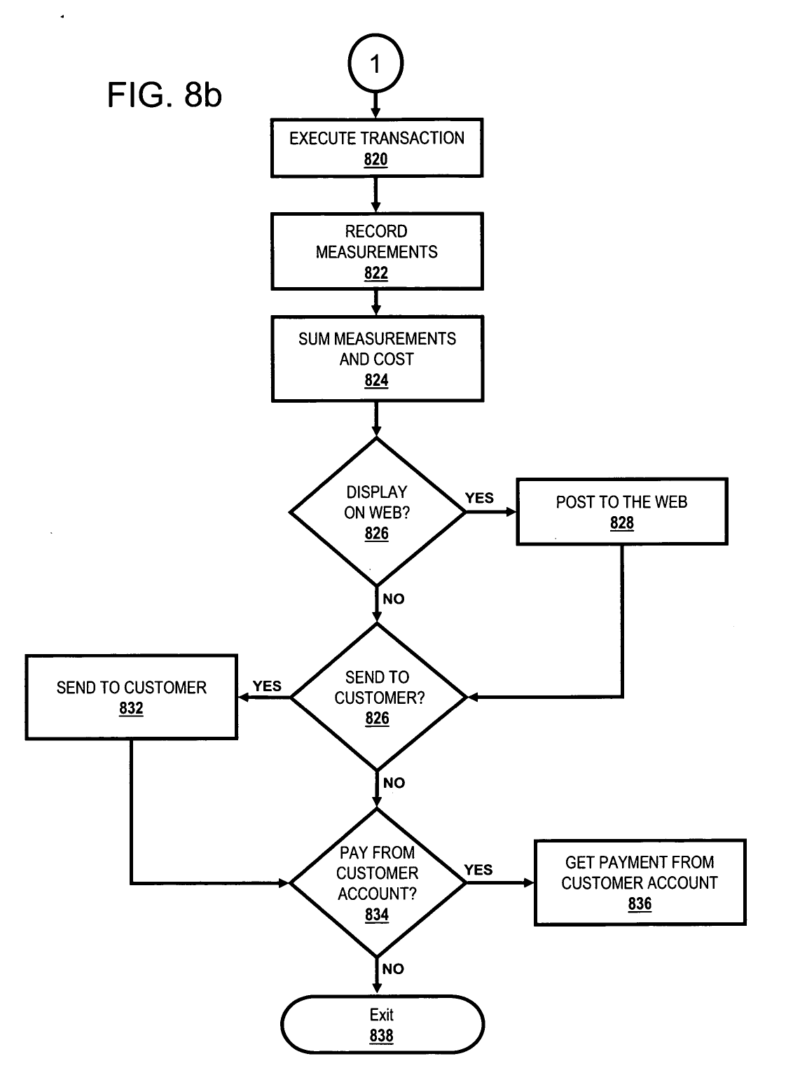

With reference now to FIG. 8, initiator block 802 begins the On Demand process. A transaction is created than contains the unique customer identification, the requested service type and any service parameters that further, specify the type of service (block 804). The transaction is then sent to the main server (block 806). In an On Demand environment the main server can initially be the only server, then as capacity is consumed other servers are added to the On Demand environment.

The server central processing unit-(CPU) capacities in the On Demand environment are queried (block 808). The CPU requirement of the transaction is estimated, then the servers available CPU capacity in the On Demand environment are compared to the transaction CPU requirement to see if there is sufficient CPU available capacity in any server to process the transaction (query block 810). If there is not sufficient server CPU available capacity, then additional server CPU capacity is allocated to process the transaction (block 812). If there was already sufficient Available CPU capacity then the transaction is sent to a selected server (block 814).

Before executing the transaction, a check is made of the remaining On Demand environment to determine if the environment has sufficient available capacity for processing the transaction. This environment capacity consists of such things as but not limited to network bandwidth, processor memory, storage etc. (block 816). If there is not sufficient available capacity, then capacity will be added to the On Demand environment (block 818). Next the required software to process the transaction is accessed, loaded into memory, then the transaction is executed (block 820).

The usage measurements are recorded (block 822). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 824).

If the customer has requested that the On Demand costs be posted to a web site (query block 826), then they are posted (block 828). If the customer has requested that the On Demand costs be sent via e-mail to a customer address (query block 830), then these costs are sent to the customer (block 832). If the customer has requested that the On Demand costs be paid directly from a customer account (query block 834), then payment is received directly from the customer account (block 836). The On Demand process is then exited at terminator block 838.

While the invention has been particularly shown and described with reference to a preferred embodiment, it will be understood by those skilled in the art that various changes in form and detail may be made therein without departing from the spirit and scope of the invention.

What is claimed is:

1. A system for loading firmware onto multiple processors, the system comprising:
a firmware controller;
multiple processors coupled to the firmware controller; and
a single dedicated memory coupled to the firmware controller, the single dedicated memory being loaded with a firmware used to boot a processor prior to loading an operating system, wherein the firmware controller selectively sends, during an initial boot process, the firmware to a receiving processor that is selected from the multiple processors, and wherein execution of the firmware occurs in the receiving processor without a copy of the firmware being stored in the receiving processor.

2. The system of claim 1, wherein the firmware controller contains means for, in response to a processor failing to execute the firmware, determining a memory address of code at which point execution of the firmware became hung.

3. The system of claim 1, wherein the multiple processors are physically on a first server blade, the system further comprising:
means for, in response to one of the multiple processors failing to fully execute the firmware, conscripting a processor from another server blade to replace a processor on the first server blade that failed to fully execute the firmware.

4. The system of claim 1, further comprising:
means for, in response to one of the multiple processors failing to fully execute the firmware, conscripting a processor from the server blade to replace a processor on the server blade that failed to fully execute the firmware.

5. The system of claim 1, wherein operations of the firmware controller are controlled by a service processor.

6. The system of claim 1, further comprising:
a dedicated bus that is used exclusively for data communication between the multiple processors and the dedicated memory that is loaded with the firmware.

7. A method for loading firmware onto multiple processors, the method comprising:
coupling a firmware controller to multiple processors;
coupling a dedicated memory that is loaded with firmware to the firmware controller;
selecting one or more of the multiple processors to be selected processors; and
directly executing the firmware in the selected processors, wherein the firmware is executed by each selected processor without storing a copy of the firmware in each selected processor.

8. The method of claim 7, further comprising:
in response to a selected processor failing to execute the firmware, determining a memory address at which point the selected processor failed to continue executing the firmware.

9. The method of claim 7, wherein the multiple processors are physically on a first server blade, the method further comprising:
in response to one of the selected processors failing to fully execute the firmware, conscripting a processor from another server blade to replace the selected processor, on the first server blade, that failed to fully execute the firmware.

10. The method of claim 7, further comprising:
in response to one of the selected processors failing to fully execute the firmware, conscripting a backup processor from the multiple processors to replace the selected processor that failed to fully execute the firmware.

11. The method of claim 7, wherein the firmware is supplied to all of the selected processors at a same time.

12. The method of claim 7, further comprising:
communicating data, between the multiple processors and the dedicated memory that is loaded with the firmware, via a dedicated bus that is used exclusively for data communication between the multiple processors and the dedicated memory that is loaded with the firmware.

13. A computer-usable medium containing computer program code, the computer program code comprising computer executable instructions configured to load firmware onto multiple processors, wherein the multiple processors are coupled to a firmware controller, and wherein the firmware controller is coupled to a dedicated memory that is loaded with firmware, and wherein the computer executable instructions are configured to perform a method comprising:
selecting one or more of the multiple processors to be selected processors; and
directly executing the firmware in the selected processors, wherein the firmware is executed by each selected processor without storing a copy of the firmware in each selected processor.

14. The computer-useable medium of claim 13, wherein the method further comprises:
in response to a selected processor failing to execute the firmware, determining a memory address at which point the selected processor failed to continue executing the firmware.

15. The computer-useable medium of claim 13, wherein the multiple processors are physically on a first server blade, and wherein the method further comprises:
in response to one of the selected processors failing to fully execute the firmware, conscripting a processor from another server blade to replace the selected processor, on the first server blade, that failed to fully execute the firmware.

16. The computer-useable medium of claim 13, wherein the method further comprises:
in response to one of the selected processors failing to fully execute the firmware, conscripting a backup processor from the multiple processors to replace the selected processor that failed to fully execute the firmware.

17. The computer-useable medium of claim 13, wherein the method further comprises:
controlling operations of the firmware controller by using software that is deployed from a remotely located third party service provider.

18. The computer-useable medium of claim 13, wherein the method further comprises:
communicating data between the multiple processors and the dedicated memory that is loaded with the firmware via a dedicated bus that is used exclusively for data communication between the multiple processors and the dedicated memory that is loaded with the firmware.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
